(19) United States
(12) Patent Application Publication
(10) Pub. No.: US 2002/0171291 A1
(43) Pub. Date: Nov. 21, 2002

(54) Vehicle mounted accessory with multiplexing

(76) Inventors: Edwin A. Wayne, Warren, ME (US); Clarence J. Rand, Rockport, ME (US)

Correspondence Address: WOOD, HERRON & EVANS, L.L.P., 2700 Carew Tower, 441 Vine St., Cincinnati, OH, 45202, US

(21) Appl. No.: 10/102,782

(22) Filed: Mar. 21, 2002

Related U.S. Application Data
(60) Provisional application No. 60/277,713, filed on Mar. 21, 2001.

(51) Int. Cl. B60L 1/00

(52) U.S. Cl. 307/9.1

(57) ABSTRACT

An apparatus for controlling an accessory that has an electrically operable device and is attachable to a vehicle. The apparatus has a switch that is mounted on the vehicle remote from the accessory and operable by an operator of the vehicle. The switch and the electrically operable device are electrically connected by controllers and a single dedicated communications wire. The apparatus has the capability of automatically determining if a DRL lighting system is present on the vehicle; and if so, accessory lights such as plow headlights are automatically illuminated to simulate the vehicle DRL lighting mode. The apparatus has the further capability of detecting an erroneous electrical operation of the electrically operable device on the accessory, for example, an excessive current.

This application is a continuation application of Provisional U.S. Serial No. 60/277,713, filed Mar. 21, 2001, entitled “Vehicle Mounted Accessory with Multiplexing”, and is hereby expressly incorporated herein by reference in its entirety.

### FIELD OF THE INVENTION

The present invention generally relates to vehicle mounted accessories and more particularly, to a multiplexing communications link between a vehicle and an accessory mounted thereon.

### BACKGROUND OF THE INVENTION

The mounting of an accessory, for example, a plow or material spreader, on a vehicle requires that accessory controls be placed in the vehicle at a location accessible to a vehicle operator, who is normally seated in a driver's seat. Upon the vehicle operator using the accessory switches, electrical signals must be transmitted from the switches to various devices on the plow or material spreader. Normally, the transfer of those signals is accomplished by running individual wires from the switches to the various devices on the plow and material spreader. Further, each of those wires must pass through one or more electrical connectors that are used to connect and disconnect the plow or material spreader from the vehicle. The relatively large number of wires used in such connectors makes the connectors relatively expensive to manufacture and somewhat awkward and difficult for a user to connect and disconnect. In addition, such electrical connectors are normally exposed to adverse weather conditions and moisture; and over time, electrical contacts within the connectors oxidize, corrode, etc. Such oxidation, etc., is detrimental to maintaining high quality electrical connections across the electrical connectors. Further, such oxidation, etc., may cause the contacts between the two coupling members of the connectors to bind together, thereby making it difficult to separate the two coupling members of the connectors without causing damage.

In order to reduce the cost and labor associated with adding large, multiconductor accessory wiring cables to a vehicle to handle control signals for an accessory, it is known to use existing vehicle wiring as a communications bus over which frequency modulated control signals for the accessories are multiplexed. While such a system does eliminate the costs associated with the manufacture and installation of the cables, other potential problems are introduced. First, there are the costs of the electronic circuits to support the encoding/decoding and multiplexing of the signals over existing vehicle wiring. Second, the existing vehicle wires are chosen for their intended use, that is, to conduct power throughout the vehicle, and are not ideal conductors for accessory control signals. Third, there is a question whether the system as a whole is sufficiently immune from outside signal interference. Fourth, there is a potential of interfering with the operation of existing or future vehicle electrical devises that are powered by, or controlled over, the vehicle power lines.

Therefore, there is a need for a system for transferring accessory control signals between a vehicle and vehicle mounted accessories using fewer connections while isolating the accessory electrically, from the vehicle as much as possible.

Accessories such as a plow that are mounted on a front end of a vehicle often obscure a daytime running light (“DRL”) on the vehicle. In such a situation, it is desirable to provide a DRL feature on the plow. However, in view of the many different ways that manufacturers implement a DRL feature, it is very difficult to practically integrate a DRL feature on an after-market product such as the plow. Therefore, there is a need to provide an accessory product that automatically implements a DRL feature if such is used on a vehicle.

### SUMMARY OF INVENTION

The present invention provides a control system for a vehicle accessory that is easy to install, flexible in its implementation and reliable in operation. The control system of the present invention has the capability of preventing damage to devices on the accessory and the control system caused by excessive electrical current. The control system of the present invention is particularly useful for a plow accessory and has the advantage of deterring theft of a plow. Further, the control system of the present invention has the advantage of automatically simulating on the plow, the lighting modes of the vehicle.

In accordance with the principles of the present invention and the described embodiments, an apparatus is provided for controlling an accessory that has an electrically operable device and is attachable to a vehicle. The apparatus has a switch that is mounted on the vehicle remote from the accessory and operable by an operator of the vehicle. The switch provides a command signal to command an operation of the electrically operable device on the accessory. A first controller is mounted on the vehicle and is electrically connected to the switch for receiving the command signal. A second controller is mounted on the accessory and is electrically connected to the electrically operable device. First and second dedicated communications wires are electrically connected to the first and second controllers, respectively; and first and second coupling members are electrically connected to the first and second dedicated communications wires, respectively. The second coupling member is connectable to the first coupling member upon the accessory being mounted on the vehicle, thereby connecting the first and second dedicated communications wires to form a single dedicated communications wire. The second coupling member is disconnectable from the first coupling member upon the accessory being removed from the vehicle. The first controller provides the command signal to the second controller via the single dedicated communications wire and the second controller operates the electrically operable device on the accessory in response to the first coupling member being connected to the second coupling member and receiving the command signal. The dedicated single wire communications system has the advantages of being less expensive and more reliable than multiple conductor direct wire systems and is more reliable than systems that do not use a dedicated communications wire.

In another embodiment of the invention, an apparatus is provided for controlling a plow having a plow light and being attachable to a vehicle having a vehicle light. The apparatus has a first controller mounted on the vehicle and electrically connected between a supply voltage and the vehicle light, the first controller automatically detects the vehicle light being operable in a DRL mode.

In one aspect of this embodiment, the apparatus has a second controller mounted on the plow and electrically connectable to the first controller upon the plow being mounted on the vehicle, the second controller automatically operates the plow light in a DRL mode in response to the first controller determining the vehicle light is operable in a DRL mode.

In a still further embodiment of the invention, an apparatus is provided for controlling an accessory that has an electrically operable device and is attachable to a vehicle. The apparatus has an accessory switch mounted inside the vehicle. The switch is remote from the accessory and operable by an operator. The accessory switch commands an operation of the electrically operable device on the accessory. A first controller is mounted proximate the accessory switch inside the vehicle and provides an accessory command signal for the electrically operable device in response to an operation of the accessory switch. A second controller is mounted on the accessory outside the vehicle and is electrically connectable to the first controller upon mounting the accessory on the vehicle. The second controller operates the electrically operable device in response to receiving the accessory command signal from the first controller. The second controller has a circuit electrically connected to the electrically operable device for detecting an erroneous electrical operation of the electrically operable device, for example, an excessive current. The second controller terminates the operation of the electrically operable accessory in response to detecting the erroneous electrical operation. Excessive current can cause damage to the operating devices as well as the controllers; and therefore, an early detection of such currents has the advantage of preventing such damage from occurring.

Various additional advantages, objects and features of the invention will become more readily apparent to those of ordinary skill in the art upon consideration of the following detailed description of the presently preferred embodiments taken in conjunction with the accompanying drawings.

### BRIEF DESCRIPTION OF DRAWINGS

FIGS. 1 is an overall schematic diagram of a vehicle with accessories and a communications system in accordance with the principles of the present invention.

FIGS. 2A and 2B are detailed schematic diagrams of a vehicle accessory control system in accordance with the principles of the present invention.

FIG. 3 is a flowchart illustrating an operation of a vehicle controller within the communications system of FIG. 1.

FIG. 4 is a flowchart illustrating an operation of a plow controller within the communications system of FIG. 1.

FIG. 5 is a flowchart illustrating a process by which the vehicle controller detects a presence of a daytime running light system on the vehicle.

FIG. 6A is a flowchart illustrating an operation of a plow switch controller within the communications system of FIG. 1.

FIG. 6B is a flowchart illustrating an operation of a material spreader switch controller within the communications system of FIG. 1.

FIG. 7 is a flowchart illustrating an operation of a material spreader controller within the communications system of FIG. 1.

### DETAILED DESCRIPTION OF THE INVENTION

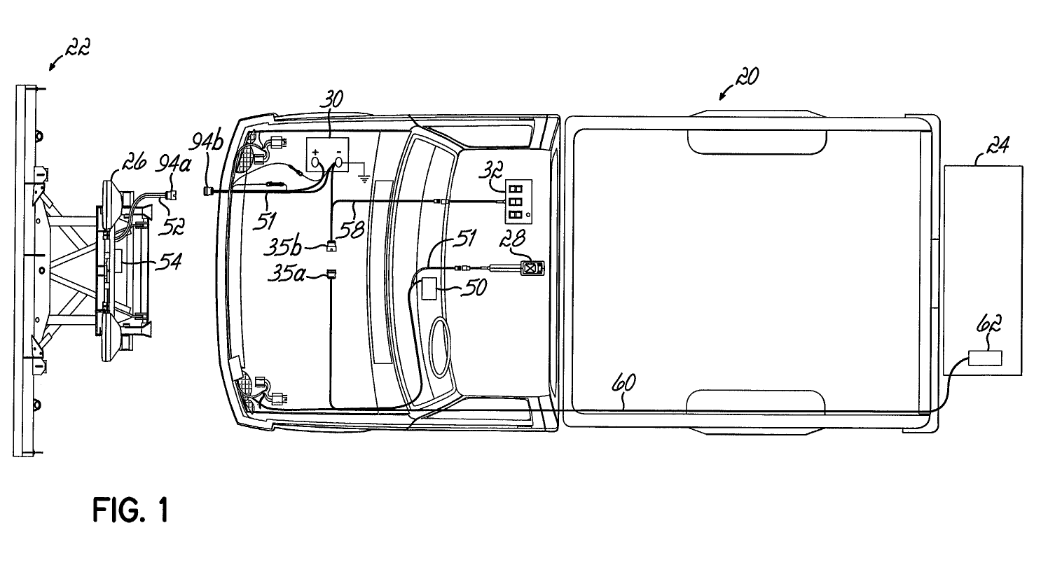

Referring to FIG. 1, during the winter months, the utility of a vehicle 20, for example, a truck, can be enhanced by mounting various accessories thereto. For example, during inclement weather, a plow 22 is often mounted to a front end of the vehicle 20 and a spreader 24 is often mounted to the rear of the vehicle 20. As will be appreciated, the plow can also be mounted to a bottom portion of the vehicle or the rear end. The spreader 24 spreads a material, for example, salt, sand, etc., that is intended to improve vehicle traction on the road. It is also necessary that devices, for example, plow lights 26 and other electromechanical devices on the plow 22, be electrically connected to a plow control 28 and a vehicle power source such as a battery 30. Those connections are implemented using cables 51, 52 and a connector 94. Similarly, it is necessary for the spreader 24 to be electrically connected to its control 32 as well as the battery 30. Normally, such electrical connections are accomplished using cables 58, 60 and a connector 35. The cables 58, 60 are normally part of a spreader wiring harness 33; and the cables 51, 52, are normally part of a plow wiring harness 34.

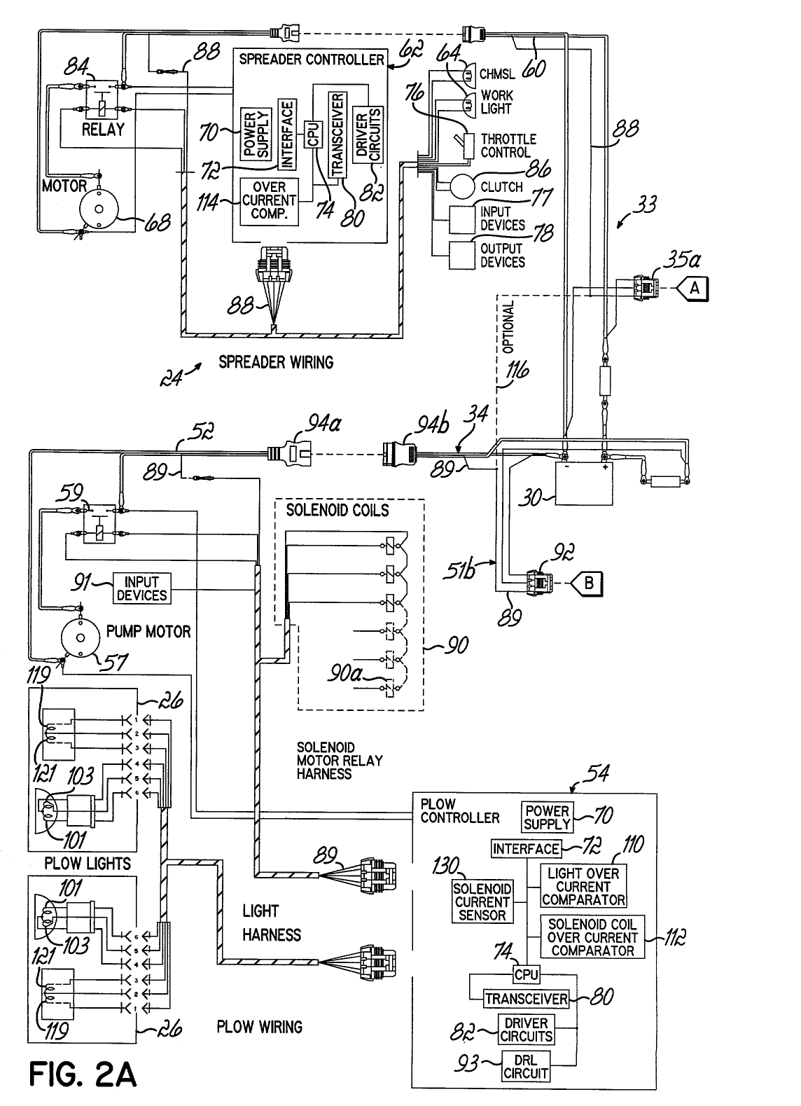

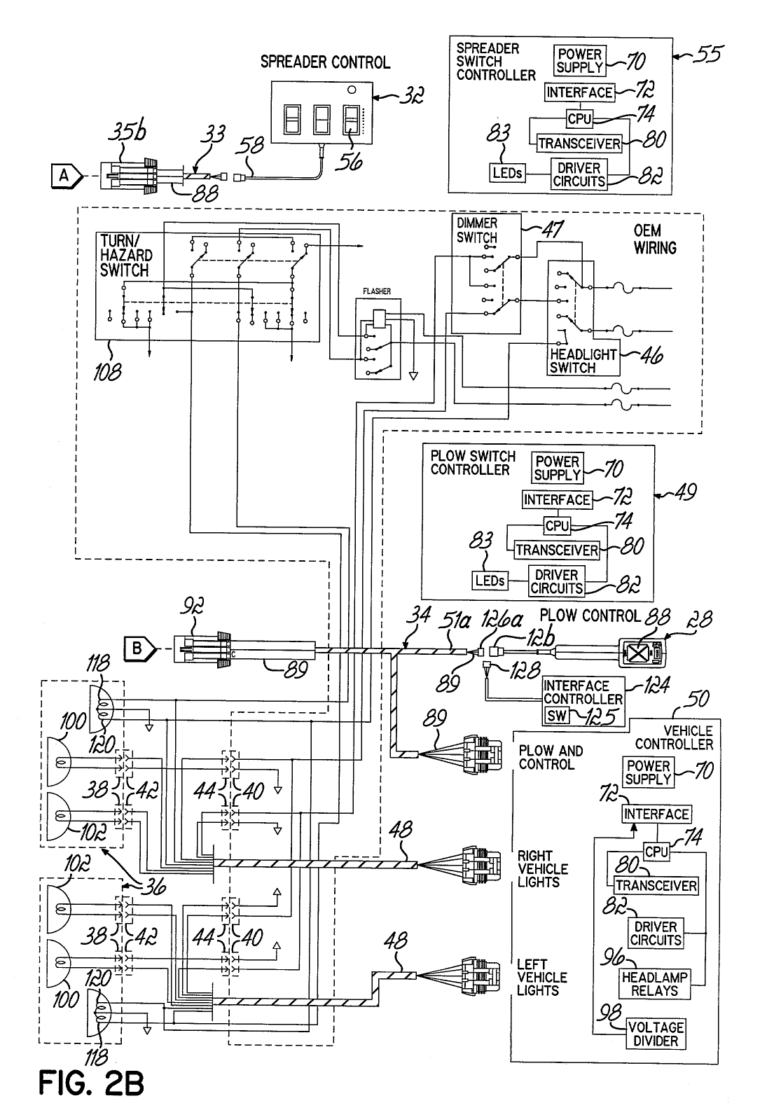

Referring to FIGS. 2A, 2B, the plow wire harness 34 is designed to minimize the work required for installation of the plow 22 and its associated control system. For example, vehicle headlights 36 have connectors 38 that normally plug into mating connectors 40 supplying power to the headlights. To install the plow lighting system, the connectors 38, 40 are separated and plugged into respective plow cable connectors 42, 44. Thus, power signals provided from respective headlight and dimmer switches 46, 47 are diverted through connectors 44 and cables 48 and into a vehicle controller 50. The vehicle controller determines whether the plow 22 is mounted on the vehicle 20 and if not, provides power signals through connectors 42 to illuminate the vehicle headlights 36 in a manner corresponding to the states of the switches 46, 47 as selected by the vehicle operator. If the plow 22 is mounted on the vehicle 20, the vehicle controller 50 opens the circuit supplying power to the vehicle lights 36 by changing the state of headlamp relays 96 and does not illuminate the vehicle headlights 36. Instead, the vehicle controller 50 provides light command signals over harnesses 51, 52 to a plow controller 54, that, in turn, illuminates the plow lights 26 in accordance with the selection of the switches 46, 47. In addition, based on a user's operation of various input switches 88, a plow switch controller 49 within the plow control 28 provides other command signals over cables 34, 51, 52 to the plow controller 54. Such command signals relate to the operation of various devices on the plow 22, for example, a pump motor 57 that provides hydraulic power to move the plow to different commanded positions in a known manner.

The spreader control 32 contains a spreader switch controller 55 that is responsive to input devices 56, for example, user operable switches, on the spreader control 32 and provides, over cables 33, 58, 60, command signals to a spreader controller 62. The spreader controller then, in turn, operates lights 64, motors 68 and other devices in accordance with the command signals provided by the spreader switches 56.

Each of the controllers 49, 50, 54, 55, 62 is substantially similar in structure and operate in generally the same way. Considering, for example, the spreader switch controller 55 and spreader controller 62, each has a power supply 70 that generally provides power to devices on the respective controllers 55, 62. Interfaces 72 provide a known function of interfacing signals from input devices to CPU's 74 within the controllers 55, 62. Thus, the interface 72 within the spreader controller 62 provides signals from input devices 77 located on the spreader 24, for example, sensors providing input signals relating to ground speed, material level, application rate, spinner speed, fault conditions, ambient road surface temperature, etc. The CPUs 74 within the controllers 55, 62 provide outputs to transceivers 80 and driver circuits 82. Within the spreader controller 62, the driver circuits 82 provide output signals to various output devices on the spreader 24, for example, lights 64, a throttle control 76, clutch control 86 and other output devices 78, for example, relays, fault indicators, etc.

Referring to the spreader switch controller 55, the interface 72 is electrically connected to spreader switches 56 that are operated by the user to command the operation of the spreader and other spreader devices. The driver circuits 82 within the spreader switch controller 55 are normally used to illuminate indicators and/or other alarms relating to the operation of the spreader 24.

The transceivers 80 within the controllers 55, 62 are in electrical communication over a single wire 88 extending between the controllers 55, 56 as part of cables 58, 60. Thus, the single wire 88 provides a dedicated communications bus utilizing a control area network (“CAN”). The single wire communications bus 88 terminates into transceivers 80 and permits the spreader controller 62 to transmit the states of input devices 77 to the spreader switch controller 55. The CPU 74 of the spreader switch controller 55 also scans the states of the spreader control switches 56. Based on the states of the input switches 56 and the input devices 77, the CPU 74 of the spreader switch controller 55 then determines the desired states of the spreader output devices 64, 76, 78, 84, 86. Again, using the single wire communications bus 88 and the transceivers 80, the spreader switch controller transmits those desired states to the spreader controller 62. The CPU 74 within the spreader controller 62 then changes the states of the drive circuits 82 so that output devices on the spreader 24 are operated in accordance with their desired states as determined by the CPU 74 within the spreader switch controller 55.

Upon installation of the plow 22, the plow control 28 is placed at a location convenient to the user, for example, the cab of the vehicle 20. The vehicle controller 50 is mounted at a convenient location on the vehicle, for example, under the dash in the cab or in the engine compartment. The cables 48 are routed from the vehicle controller 50 to the location of the vehicle lights, and connectors 42, 44 are connected to connectors 38, 40, respectively. The cable 51a provides a first dedicated communications wire and is connected to the plow switch controller 49 and the vehicle controller 50, routed through the engine compartment and connected to a power cable 51b that is connected to the battery and terminates with connector 94b. Upon installation of the plow control 28 in the vehicle 20, the connectors 92 are connected and remain connected. Connecting the connectors 92 supplies power to the plow control 28 and controllers 49, 50 and routes a single wire communications bus 89 between the connector 94b and the controllers 49, 50. Cable 52 provides a second dedicated communications wire 89 between the connector 94a and the plow controller 54.

After the plow 22 has been initially installed, upon mounting and dismounting the plow 22 from the front of the vehicle 20, all electrical connections to the plow are made and broken by simply connecting and disconnecting the connectors 94a, 94b. Connecting connectors 94a, 94b provides power to the plow controller 54. The plow lights 26, plow controller 54, pump motor 57, solenoids 90 and related electrical components are physically mounted on the plow 22 (FIG. 1). In addition, connecting connectors 94a, 94b forms a single dedicated communications wire between the vehicle controller 50, the plow switch controller 49 and the plow controller 54. Thus, the plow switch controller 49, vehicle controller 50 and plow controller 54 are in electrical communications by means of extending the CAN communications bus implemented via the single wire 89 extending through cables 51, 52 and connector 94 between the transceivers 80 in each of the controllers 49, 50, 54.

Plow control switches 88 allow the user to provide commands to raise, lower, rotate, extend and retract, that is, position, the plow in a known manner. The functions of the input switches 88 will vary depending on whether the plow 22 has a straight blade or a multi-position blade. The signals from the input switches 88 are provided to the interface 72 within the plow switch controller 49 , and the CPU 74 of the plow switch controller 49 reads and stores the input signals from the switches 88. If appropriate, the CPU 74 of the plow switch controller 49 provides output signals to driver circuits 82 to illuminate sensory perceptible indicators, for example, LEDs 83 on the plow control 28, thereby indicating the operating status of the plow to the user. In addition, the CPU 74 within the plow switch controller 49 uses the single wire communications bus 89 and connected transceivers 80 to transfer desired output states of the solenoids 90, pump motor 57 via relay 59, and plow lights 26 to the plow switch controller 54. In addition, the CPU 74 within the vehicle controller 50 reads the states of the light switches selected by the user and uses the single wire communications bus 89 to transmit those desired light states to the plow controller 54.

The CPU 74 within the plow controller 54 receives the desired states of lights and the output devices and activates its driver circuits 82 accordingly, thereby causing the operating states of the solenoids 90, pump motor 57, relay 59 and plow lights 26 to correspond to the desired states determined by the plow switch controller 49 and vehicle controller 50. The interface 72 of the plow controller 54 is connected to input devices 91, for example, sensors and/or limit or proximity switches, that monitor or are activated by the operation of the plow 22. The interface 72 provides input signals from the input devices 91 to the CPU 74 that, in turn, reads and stores the operational states of the input devices 91. The plow controller 54 also has current sensors or current comparators 110, 112 that detect an excessive current being used by the plow lights 26 and solenoids, respectively. Excessive current detection results in an error signal. The CPU 74 within the plow controller 54 uses the single wire communications bus 89 and connected transceivers 80 to transfer the states of the input signals and the error signal, if any, to the plow switch controller 49.

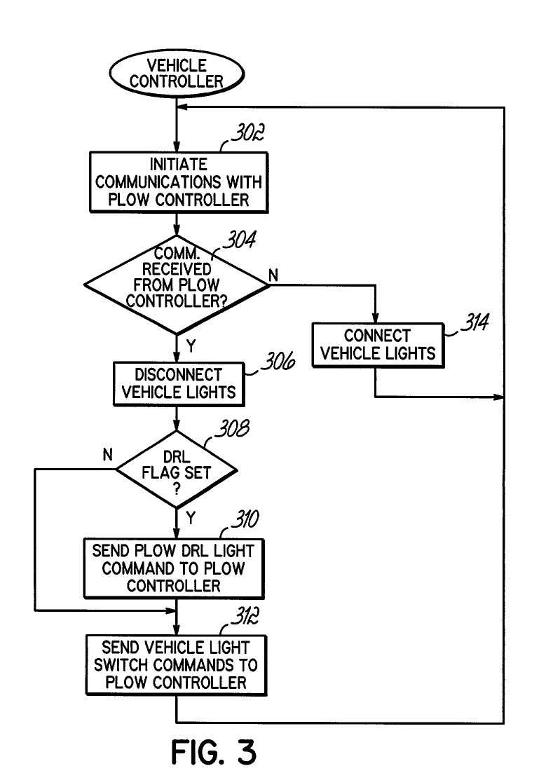

In use, referring to FIG. 3, at 302, upon connecting connectors 92, power is applied to the vehicle controller 50; and the CPU 74 within the vehicle controller 50 continuously attempts to initiate communications with the plow controller 54 over the single wire communications bus 89. If the plow 22 is not mounted on the vehicle and the connectors 94 are not connected, the vehicle controller 50 will not be able to complete a communications link with the plow controller 54 over the single wire communications bus 89. If there is no communications as detected at 304, the CPU 74 within the vehicle controller 50 then, at 314, switches the state of an electronic switch, for example, headlamp relays 96, to a default state. The headlamp relays 96 are effective to connect and to disconnect the low and high beam vehicle headlights 100, 102 to and from, respectively, the headlight switches 46, 47. When the relays 96 are in the default state, the switches 46, 47 control the operation of the low and high beam vehicle headlights 100, 102, respectively. The CPU 74 within the vehicle controller 50 continues, at 302, to attempt to complete communications with the plow controller 54. When the plow 22 is mounted on the vehicle 20 and the connectors 94 are connected, the CPU 74 within the plow controller 54 answers the request for communications from the vehicle controller 50 as detected at 304; and the CPU 74 within the vehicle controller 50 then proceeds to switch the state of the headlamp relays 96. If the vehicle controller 50 detects, at 304, that the plow 22 is connected to the vehicle 20, the vehicle controller 50, at 306, switches the headlamp relays 96 to a state disconnecting the vehicle headlamps 100, 102 from their respective voltage supply lines that may be connected directly to the headlight switches 46, 47 as shown in FIG. 2B.

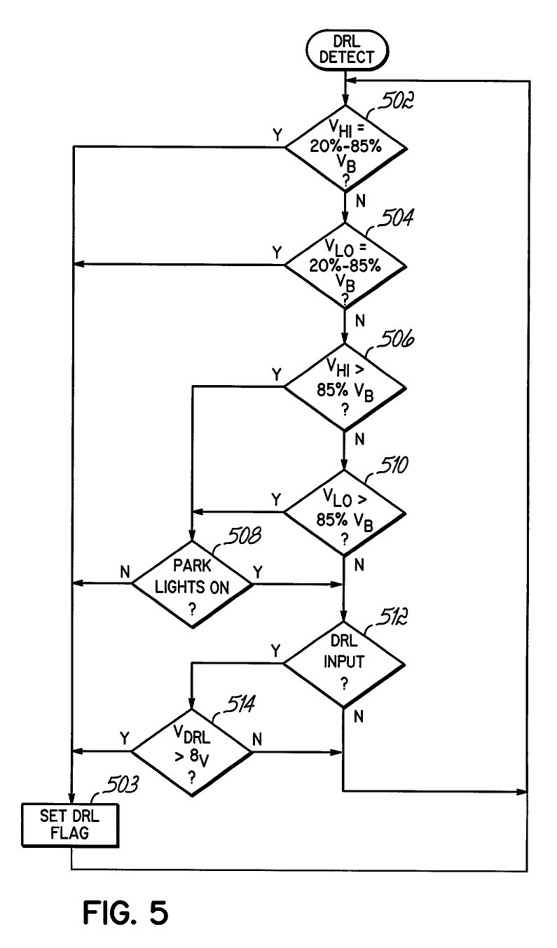

Next, at 308, the vehicle controller determines whether a daytime running light (“DRL”) flag is set. At any time when the plow is not mounted on the vehicle, the vehicle controller 50 has the capability of automatically detecting whether the vehicle lights 36 are operating in a DRL mode. To detect an operating state of the DRL mode, the vehicle controller 50 utilizes voltage dividers 98 that measure supply voltages for the low beams 100 and high beams 102. Those voltages are provided to an A/D converter input of the CPU 74 of the vehicle controller 50. Referring to FIG. 5, the vehicle controller CPU, at 502, determines whether the high beam supply voltage is in a range of from about 20%-85% of the magnitude of the battery voltage. If it is, a DRL flag is set at 503. If not, the CPU then, at 504, determines whether the low beam supply voltage is in a range of from about 20%-85% of the battery voltage. If so, the DRL flag is again set. If not, the CPU then, at 506, determines whether the high beam supply voltage exceeds about 85% of the battery voltage. If so, a determination is then made, at 508, whether the parking lights are on. If the parking lights are off, the DRL flag is set. If the high beam supply voltage does not exceed about 85% of the battery voltage, the CPU then, at 510, determines whether the low beam supply voltage exceeds about 85% of the battery voltage. Again, if so, and if the parking lights are not on, the DRL flag is set. The CPU then, at 512, determines whether a signal exists on a DRL input to the vehicle controller 50. Some vehicle lighting systems have a separate signal line for the DRL lighting; and if a signal exists on that line, the CPU then, at 514, determines whether the voltage on the DRL input is greater than about 8 volts. If so, the DRL flag is set at 503.

Referring back to FIG. 3, if it is determined that a DRL flag is set, at 308, the CPU 74 in the vehicle controller 50 proceeds, at 310, to send a DRL signal to the plow controller 54 via the transceivers 80 in each of the controllers 50, 54 and the single wire communications bus 89. In that process, within the vehicle controller 50, the commands are passed to the transceiver 80 from the CPU 74. The transceiver 80 functions independently of the CPU 74 and encodes each of the commands as part of a signal multiplexing process. The encoded commands are then transmitted over the single wire communications bus 89. The encoded command signals are received and decoded in the transceiver 80 of the plow controller 54 and transferred to the CPU 74 for storage. The above multiplexing process is implemented with the transceivers 80 in a known manner.

Thus, the vehicle controller 50 automatically determines a presence of a DRL mode. When a plow 22 is mounted on the vehicle 20, the vehicle controller 50 sends the DRL signal to the plow controller 54; and the CPU 74 in the plow controller 54 operates with a DRL circuit 93 to automatically illuminate the plow lights 26 in a DRL mode.

The user selects the operating states of the low and high beam vehicle headlights 100, 102 by using switches 46, 47. Further, by using switches 108, the user commands the states of the vehicle turn signal lights 118, and the vehicle headlight switch 46 is used to command vehicle park lights 120. When those switches are operated by the user, appropriate supply voltages are applied to the wires/circuits connected to the lights. By interposing the connectors 42, 44 between the existing vehicle connectors 38, 40, the CPU 74 of the vehicle controller 50 is able to monitor the voltages supplied to the vehicle lights 36. Thus, the vehicle controller 50 is able to automatically identify which vehicle lights are being switched on and off by the user; and in response thereto, the vehicle controller 50 provides light switch commands to the plow controller 54 utilizing the transceivers 80 in the controllers 50, 54 and the interconnecting single wire communications bus 89. The vehicle controller 50 continues to execute the process of FIG. 3 until power is removed.

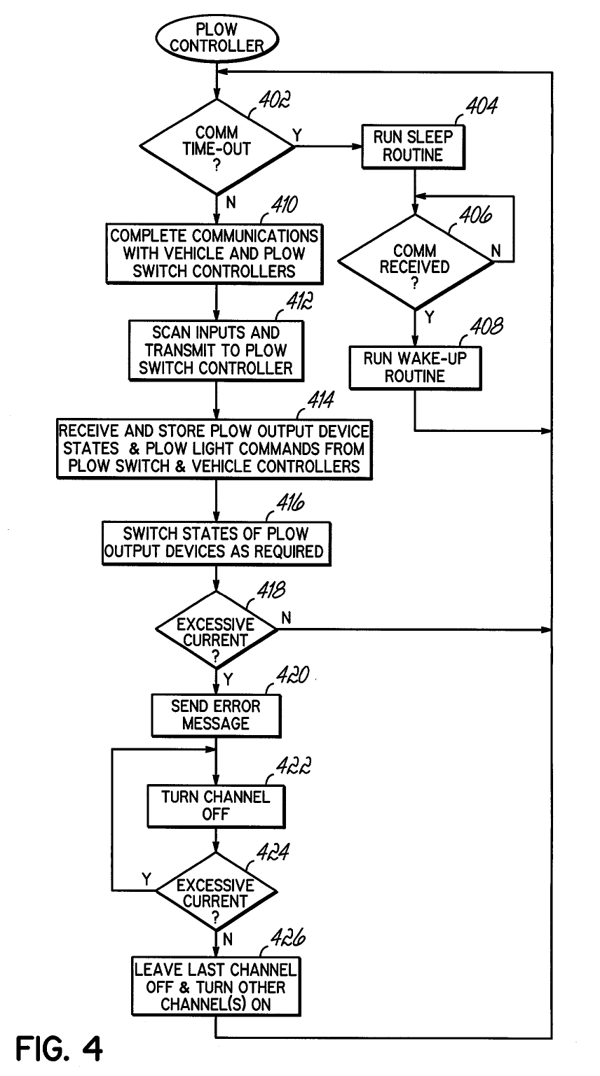

Referring to FIG. 4, the CPU 74 within the plow controller 54 first, at 402, determines whether there has been a communication timeout. Each time the plow controller 54 receives a communication from either the vehicle controller 50 or the plow switch controller 49, a communication timer is reset and started. If the plow controller 54 does not receive any communications from either the vehicle controller 50 or the plow switch controller 49 for a predetermined time period, for example, 20 minutes, the communications timer times out and the CPU 74, at 404, executes a sleep routine. In essence, the sleep routine is a minimum power operating routine for the plow controller 54. If, at any time, the CPU 74 within the plow controller 54 detects, at 406, a communication from either the plow switch controller 49 or the vehicle controller 50, the CPU 74 then executes a wake up routine at 408. The wake up routine places the plow controller 54 in its normal operating state. If a communications timeout is not detected, at 402, the CPU 74 within the plow controller 54 then, at 410, completes and confirms communications with the vehicle controller 50 and plow switch controller 49 via the transceivers 80 and single wire communications bus 89. Next, at 412, the CPU 74 of the plow controller 54 scans the inputs on the interface 72 that represent the states of the input devices 91 on the plow 22. The states of the input devices are stored within the plow controller 54 and transferred to the plow switch controller 49 via the transceivers 80 and single wire communications bus 89. In addition, at 412, if the CPU 74 of the plow controller 54 detects an excessive current from the current comparators 110, 112, an error signal is produced and also transmitted to the plow switch controller 49 via the single wire communications bus 89.

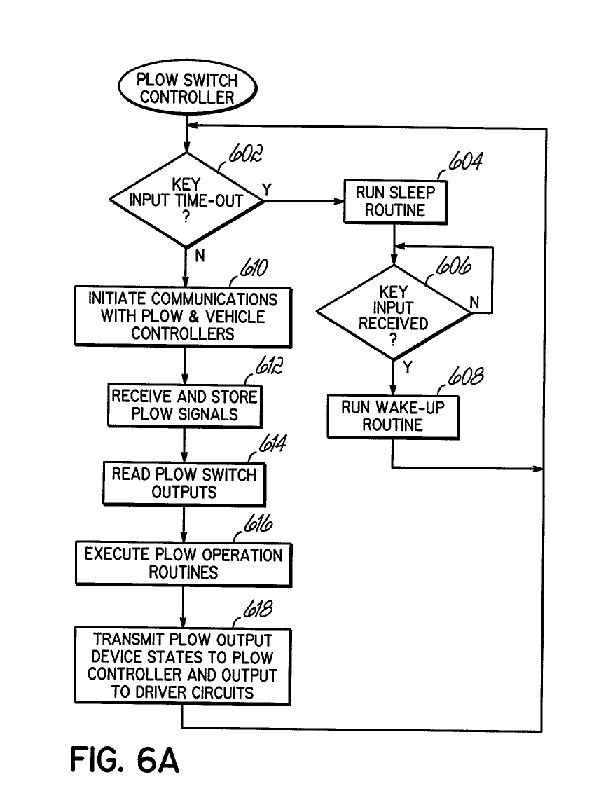

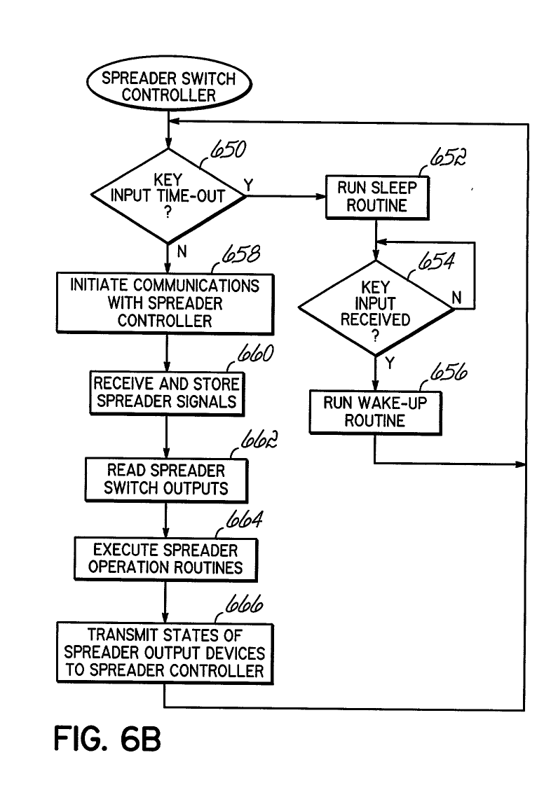

Referring to FIG. 6A, the plow switch controller 49 has a low power sleep routine based on a key input timeout. In other words, if the CPU 74 within the plow switch controller 49 fails to detect, at 602, an operation of one of the input switches 88 for a predetermined period of time, for example, 20 minutes, a sleep routine, at 604, is executed. Upon detecting the next operation of any of the input switches 88, at 606, a wake up routine is run, at 608. Thereafter, the CPU 74 within the plow switch controller 49 initiates, at 610, communications with other controllers, for example, either the plow controller 54 or the vehicle controller 50.

If communications are established, the CPU 74 of the plow switch controller 49 receives and stores, at 612, the states of the plow input devices 91, error signals, if any, and other device states transmitted by the plow controller 54. The CPU 74 of the plow switch controller 49 then reads, at 614, the current states of the plow switches 88 representing the desired user-commanded operation of the plow. Thereafter, the CPU 74 of the plow switch controller 49 executes, at 616, one or more plow operation routines to determine the desired states of the plow output devices that conform to the user commands and existing conditions on the plow as determined by the input devices 91 and the current comparators 110, 112. The CPU 74 of the plow switch controller 49 then proceeds, at 618, to transmit the desired states of the plow output devices to the plow controller 54 over the single wire communications bus 89. During the execution of the plow operation routines, at 616, the plow switch controller CPU also determines whether output devices, for example, sensory perceptible indicators such as LEDs 83, associated with the plow control 28 should be turned on or turned off. The operation of the LEDs 83 normally results from either the user operating the switches 88 or the plow controller 54 transmitting an error signal to the plow switch controller 49. In either event, within the plow switch controller 49, the CPU 74 activates the driver circuits 82 to turn on or off the LEDs 83. The CPU 74 of the plow switch controller 49 then continuously iterates the operation of FIG. 6A.

Referring back to FIG. 4, CPU 74 within the plow controller 54 receives and stores, at 414, the desired states of the plow output devices from the plow switch controller 49. In addition, the CPU 74 of the plow controller 54 receives and stores the plow light commands transmitted by the vehicle controller 50. The plow light commands include the DRL plow light commands and the vehicle light switch commands that were determined by the CPU 74 of the vehicle controller 50 and sent to the plow controller (310, 312 of FIG. 3). Thereafter, at 416, the CPU 74 of the plow controller 54 switches the states of the driver circuits 82 so that the plow lights 26 and other plow output devices 57, 90, etc., are operated in accordance with their desired commanded states. For example, if a DRL mode was detected by the vehicle controller 50, a DRL light command is sent from the vehicle controller 50 to the plow controller 54. The CPU 74 of the plow controller 54 operates with a DRL circuit 93 to illuminate the plow lights headlights 101, 103 in a manner to provide a DRL system. For example, normally, the low beams are turned on at a reduced light intensity using a pulse width modulator within the DRL circuit 93. The pulse width modulator can be implemented with either hardware or software embodiments. In addition, the vehicle controller 50 also detects whether the vehicle turn signal lights 118 and/or the vehicle park lights 120 are illuminated. If so, light commands corresponding to those operating states are transmitted to the plow controller 54; and at 416, the plow controller 54 activates driver circuits 82 causing corresponding plow turn signal lights 119 and plow park lights 121 to be illuminated.

As can be appreciated, the plow lights 26 and other devices on plow 22 operate under very difficult conditions such as extreme moisture and temperature exposure. In addition, the vehicle 20 may inadvertently strike objects due to slippery road conditions. Thus, the plow lights 26 and other output devices are subject to physical damage that may lead to electrical short circuits. Not only do such short circuits disable the plow devices associated therewith, but such short circuits have the potential for electrically damaging the controller 54 that is powering the plow devices. Therefore, the controller 54 uses over-current comparators 110, 112 to detect short circuit conditions.

During the operation of the plow devices, the light over-current comparator 110 within the plow controller 54 monitors the current flowing through the plow lights 26. If at 418, the CPU 74 in the plow controller 54 detects an excessive current, an error message is forwarded to the plow switch controller 49 resulting in one or more alarms or displays emanating from the plow control 28 indicating to the user that a problem exists. In addition, the CPU 74 of the plow controller 54 turns off, at 422, a channel corresponding to one of the driver circuits 82. The CPU 74 again determines, at 424, whether excessive current is being detected by the current comparator 110. If so, a second channel or driver circuit 82 connected to another plow light is turned off. This process continues until one of the driver circuits 82 is turned off that is connected to the shorted lighting circuit. Having identified the shorted lighting circuit, the CPU 74 of the plow controller 54 then, at 426, maintains the last channel or driver circuit in an off state and turns on one or more other channels to provide an appropriate lighting situation. For example, if it is determined that either the high beam or the low beam of one of the plow lights is in the defective circuit and being turned off, the CPU 74 will automatically turn on a corresponding vehicle headlight, so that a headlight is always on if there is a DRL light command or a light switch command.

The solenoid over-current comparator 112 within the plow controller 54 operates in substantially the same way as described with respect to the light over-current comparator 110. When the CPU 74 of the plow controller 54 tests for an excessive current, at 418, it is able to test both the light over-current comparator 110 and solenoid over-current comparator 112. Further, a process similar to that described with respect to steps 418-426 is executed in response to detecting excessive solenoid current. Thus, the CPU 74 of the plow controller 54 sequentially turns off a driver circuit 82 connected to each of the solenoids 92 until the defective solenoid is found. Thereafter, that channel or driver circuit 82 is maintained off and other driver circuits and solenoids may be, if appropriate, turned back on by the CPU 74 of the plow controller 54.

The above described control system further includes the capability of providing a secure communication link between the plow switch controller 49 and the plow controller 54. When not in use, unattached plows are often left at locations where they are accessible to others. Therefore, anyone having a plow control of a particular manufacturer installed on a vehicle can approach an unattached plow, attach it and drive away. However, if the communications between the controllers of a particular vehicle and a particular plow are secured, for example, with a security code, then an unauthorized person cannot operate a plow with a different, unauthorized plow control. Thus, the employment of such security measures can help to deter plow thefts. Communications between controllers on the vehicle 20 and the plow 22 can be secured using one or more known techniques and can be implemented in software or hardware. For example, security codes can be imbedded in the communications software that is either accessible or inaccessible to the user. Alternatively, user accessible switches can be used to set passwords into the system.

In one embodiment, the security system can be enabled or disabled by a user operating plow control switches 88 that are electrically connected to the plow switch controller 49. Upon the security system being enabled, the plow switch controller 49 generates a random 8 bit binary security code that is stored in the plow switch controller 49. The plow switch controller 49 then transmits the security code to the plow controller as described with respect to step 610 of FIG. 6A. The plow controller 54 receives and stores the security code as described with respect to step 414 of FIG. 4. The next time that the plow 22 is electrically connected to the vehicle 20 via the connectors 94a, 94b, the plow switch controller 49 transmits its security code to the plow controller; and the plow controller 54 answers or completes communications with the plow switch controller 49 per step 410 of FIG. 4. If the security code received by the plow controller 54 matches its stored security code, the plow controller 54 operates normally. However, if the security code received from the plow switch controller does not match the security code stored in the plow controller 54, the plow controller 54 disables, that is, does not provide output signals to, the solenoids 90 that operate the hydraulic system; and the user is unable to move or otherwise operate the plow 22. Thus, the use of a security code that is automatically generated by, and embedded in, the software is effective to limit the unauthorized use of the plow 22. The security code remains active until the security system is disabled by the user; and when the security system is again enabled, a new security code is generated.

However, there are other situations where it is desirable that the user have control over the generation of the security code. For example, the user may have several vehicles that should be connectable to a particular plow. Therefore, each of those vehicles and the plow should have the same security code. In this embodiment, an interface controller 124 (FIG. 2B) having a power supply, CPU, interface and transceiver similar to the other controllers, also has, as inputs, switches 125 that are used to permit the user to select a particular numerical security code. To install the interface controller 124, connectors 126a, 126b between the plow control 28 and the cable 51a are separated and reconnected to a 3-way or T-connector (not shown). A connector 128 from the interface controller 124 is connected to the third input of the T-connector; and in a manner similar to that described earlier, upon the connector 128 being connected to the T-connector, communications are established between the interface controller 124 and the plow switch controller 49 via the single wire communications bus 89. The user is then able to use the switches 125 to set a security code into the plow switch controller 49. With the plow 22 mounted on the vehicle, the security code is transmitted to, and stored in, the plow controller 54. Thereafter, the connector 128 and the T-connector are removed, and the connectors 126a, 126b are reconnected. The user repeats the process for each vehicle that is to have a security code. Thereafter, upon the security code feature being enabled by the user, the plow switch controller 54 will not operate the solenoids 90 that control the plow hydraulics if the security code being transmitted by the plow switch controller 49 does not match the security code stored in the plow controller 54.

Another feature of the above-described control system is the ability to automatically detect a particular type of accessory that is mounted on the vehicle 20, for example, either a straight blade plow or a V- blade plow can be mounted on the vehicle 20. Further, each of those plows has a different plow control that must be installed by the user upon the plow being mounted on the vehicle. With such known systems, it is the responsibility of the user to properly install a plow control that matches the plow being mounted on the vehicle. Thus, it would be a significant advantage to be able to automatically detect the type of plow that is mounted on the vehicle and automatically reprogram the plow control 28, so that the functions of the switches 88 match the requirements of the mounted plow. Multiple function switches on plow controls is known; and one such embodiment is described in U.S. Pat. No. 6,253,470 for “Hydraulic and Electrical Control Systems for Use with Vehicle Accessory Units”, the entirety of which is hereby incorporated herein by reference Referring to FIG. 2A, there are numerous solenoids 90 on the plow 22 that are operated by the plow controller 54, and those solenoids 90 are operably connectable to different hydraulic components (not shown) on the plow in a known manner. A straight blade plow is relatively simple to control, and therefore, only uses a few solenoids to control its operation. In contrast, the V-blade plow can be operated to orient the V-blade in different configurations depending on the plowing application. Thus, the control of a V-blade plow is substantially more complicated, and more solenoids must be used. Further, there is at least one solenoid 90a that is always used with a V-blade plow and is never used with a straight blade plow.

When a plow 22 is mounted on the vehicle 20 and the connectors 94a, 94b are connected, communications are automatically initiated over the single wire communications bus 89 between the vehicle controller 50, the plow controller 54 and the plow switch controller 49 as previously described with respect to FIGS. 3, 4, and 6A. Thereafter, at 412 of FIG. 4, the plow controller scans various inputs and transfers the states of respective inputs to the plow switch controller 49. One of the inputs scanned is solenoid current sensor 130. The solenoid current sensor 130 is operative to detect the presence of solenoid 90a by detecting a current flow through the solenoid, that is, electrical continuity with the solenoid 90a. If the solenoid 90a is present, the solenoid current sensor 130 provides an input signal to the plow controller 54 having a first state indicating that a V-blade plow is attached. However, if the solenoid 90a is not present, the input signal from the solenoid current sensor 130 has an opposite state indicating that a V-blade plow is not attached; but instead, a straight blade plow is attached. As described at step 612 of FIG. 6A, the plow switch controller 49 receives the various signal states from the plow controller 54; and in response to a signal state indicating the presence of the solenoid 90a, the plow switch controller automatically programs the switches 88 of the plow control 28 to operate a V-blade plow. However, if the plow switch controller 49 receives a signal state indicating that the solenoid 90a is not present, it automatically programs the plow control switches 88 to operate a straight blade plow. Therefore, the automatic plow blade detection eliminates the requirement that the user manually program the plow switch controller 49 when a plow blade is attached.

The spreader switch controller 55 and spreader controller 62 operate in a manner similar to that described with respect to the plow switch controller 49 and plow controller 54. Referring to FIG. 6B, the CPU 74 within the plow switch controller 55 executes, at 652, a sleep routine in response to detecting, at 650, an absence of an operation of the spreader control switches 56. After detecting the presence of an input from one of the switches 56, the CPU 74 executes a wake up routine, at 656, and proceeds, at 658, to initiate communications with the spreader controller 62.

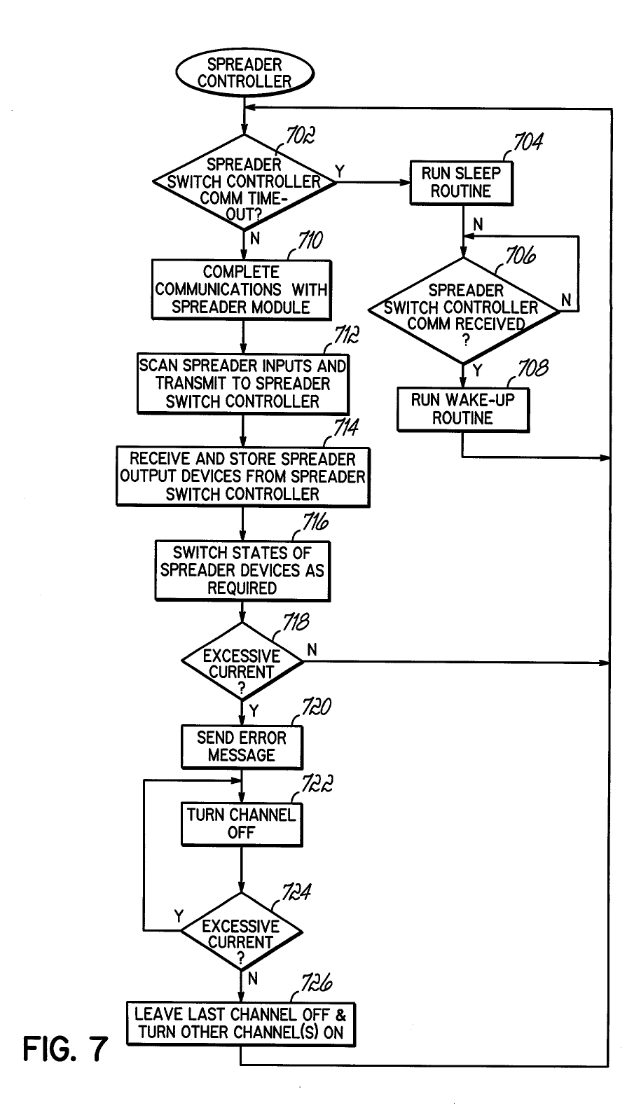

Referring to FIG. 7, the CPU 74 within the spreader controller 62 executes a sleep routine, at 704, in response to detecting, at 702, an absence of communications from the spreader switch controller 55 for a period of time. Upon detecting a subsequent spreader controller communication, at 706, a wake up subroutine is executed at 708. Thereafter, the CPU 74 within the spreader switch controller 55 completes the communications protocol with the spreader controller at 710. Thereafter, the CPU 74 within the spreader controller 62 scans the states of the input devices 77. The spreader controller 62 also has a sensor or over-current comparator 114 that detects an excessive current being used by one or more devices 64, 68, 76, 78, 84, 86 on the spreader 24. Excessive current readings result in an error signal. The CPU 74 of the spreader controller 62 transmits the error signal and the states of input devices 77 to the spreader switch controller 55 utilizing the transceivers 80 within the controllers 55, 62 and the single wire communications bus 88.

Referring to FIG. 6B, the CPU 74 within the spreader switch controller 55 receives and stores, at 660, error signal states, if any, the states of input devices 77 and other signal states associated with the spreader 24. Within the spreader switch controller 55, the CPU 74 also reads, at 662, the states of the inputs to the interface 72 which are determined by the user operating the spreader control switches 56. Thereafter, the CPU 74 of the spreader switch controller 55 executes, at 664, one or more spreader operation routines to determine the desired states of the spreader output devices that conform to the user commands and existing conditions on the spreader as determined by the input devices 77 and over-current comparator 114. The CPU 74 of the spreader switch controller 55 then proceeds, at 666, to transmit the desired states of the spreader output devices to the spreader controller 62 over the single wire communications bus 88. During the execution of the spreader operation routines, at 664, the spreader control CPU also determines that output devices, for example, sensory perceptible indicators such as LEDs 83, associated with the spreader control 32 should be turned on or turned off. The operation of the LEDs 83 normally results from either the user operating the spreader control switches 56 or the spreader controller 62 transmitting an error signal to the spreader switch controller 55. In either event, within the spreader switch controller 55, the CPU 74 activates the driver circuits 82 to turn on or turn off the LEDs 83. The CPU 74 of the spreader switch controller 55 then continuously iterates the operation of FIG. 6B.

Referring to FIG. 7, the CPU 74 of the spreader controller 62 receives and stores, at 714, the states of the spreader output devices, and, at 716, the CPU 74 of the spreader controller 62 switches the states of the driver circuits 82 for the spreader devices, thereby operating the spreader 24 in accordance with the user operating the switches 56 on the spreader control 32. In a similar manner, as described with respect to the plow controller 54, the over-current comparator 114 monitors the current being supplied to the output devices of the spreader 24. The spreader controller CPU 74 checks for excessive current, at 718; and if it is detected, an error message is forwarded, at 720, to the CPU 74 within the spreader switch controller 55 via the single wire communications bus 88 interconnecting the transceivers 80 within the controllers 55, 62. The CPU 74 within the spreader switch controller 55 then provides output signals to the driver circuits 82 to operate visual displays or other alarms associated with the spreader control 32.

Referring back to FIG. 7, the CPU 74 within the spreader controller 62 then, at 722, proceeds to turn off a channel corresponding to one of the driver outputs 82 within the spreader controller 62. A check is again made, at 724, for excessive current using the over-current comparator 114; and if it is detected, a further channel is turned off at 722. That process iterates until, at 722, a channel is turned off that is the source of the excessive current. Thereafter, at 726, the CPU 74 within the spreader controller 62 leaves the last channel tested off and turns on other channels and driver circuits 82 as appropriate to continue the operation of the spreader 24 to the extent possible under the circumstances.

The vehicle mounted accessory system described herein uses a distributed multi-controller system comprised of CPU-based controllers 49, 50, 54, 55, 62 electrically interconnected with a dedicated single wire communications bus 89 that transmits signals therebetween. The dedicated single wire communications system has an advantages of being less expensive and more reliable than multiple conductor direct wire systems and is more reliable than systems that do not use a dedicated communications wire. The dedicated single wire communications system is particularly useful for plow attachments which require a logical switching of the vehicle and plow headlights. With the distributed multi-controller system described herein, plows can be attached and reliably operated with minimal effort. A further advantage is provided in that communications between the plow operating devices and the plow control can be made secure, so that the plow operating devices are operated by only one plow control. Such a limitation has the advantage of deterring theft of the plow.

The distributed multi-controller system described herein has a further feature of being able to automatically detect the presence and operating state of a DRL system on the vehicle. Further, if a DRL system is detected to be operating, the plow headlights are automatically switched to a DRL operating mode in which they are illuminated at a reduced intensity. With such a feature, the full utility of the vehicle lights is automatically maintained when the plow is attached. The automatic DRL detection and operation has the advantage of improving the performance of the plow without complicating the plow installation.

The distributed multi-controller system described herein has a further capability of detecting an excessive current being drawn by operating devices on the accessory, for example, a plow, spreader, etc. Excessive current may be the result of physical damage to the accessory and normally is not discernible to the operator. However, excessive current can cause damage to the operating devices as well as the components in the control system. Therefore, an early detection of such currents has the advantage of preventing such damage from occurring.

The distributed multi-controller system described herein has a still further capability of providing secure communications between the controllers so that only specific devices can be operated by a particular vehicle. Thus, the capability of operating a plow with an unauthorized control system is virtually eliminated, thereby substantially reducing the ability of someone to steal an unattended and accessible plow.

The distributed multi-controller system has a yet further capability of being able to automatically detect specific type of accessory, for example, a plow, mounted on the vehicle, and then automatically reprogram the plow control switches to operate that specific plow. This feature eliminates the need to provide multiple plow controls for the different types of plows; and further, this feature eliminates the requirement that the user correctly install a plow control that matches the type of plow being mounted on the vehicle. This capability provides significant savings and convenience in the use of the plow system.

The control system described herein has another feature that enhances the operation of a plow. When switches 88 on the plow control 28 are activated by a user to command an operation of the plow 22 in a manner as described herein, that command is transferred to the plow controller 54 via the plow switch controller 49. The plow controller 54 then activates driver circuits 80 to turn on the pump motor 57 via relay 59 and switch one of the solenoids 90 that is effective to port hydraulic oil from the pump motor 57 to a hydraulic actuator that causes the plow to move as commanded. However, when a stop command is generated by the user and transmitted to the plow controller 49, the plow controller modifies a normal stop operation of the plow. Normally, the pump motor 57 is shut off simultaneously with the switching of the one of the solenoids 90, thereby shutting off the pump motor 57 and terminating hydraulic oil flow to the hydraulic actuator controlling the plow motion. Such an abrupt stop of the system is noisy and is hard on the components of the hydraulic system; and therefore, the control system of the present invention provides an alternative method of shutting off the hydraulics. In response to the stop command, the pump motor is immediately turned off, however, the switching of one or more of the solenoids 90 is delayed slightly, for example, about 0.5 seconds. That delay permits oil pumped by the motor in the process of shutting off to flow to the hydraulic actuator. That process dissipates that oil by permitting a small movement of the hydraulic actuator and plow. At the end of the delay period, the one or more of the solenoids 90 is switched, thereby hydraulically disconnecting the hydraulic actuator from the pump motor 57. Thus, the plow is brought to a smooth and soft stop in response to a stop command instead of the hard stop resulting from the normal operation.

While the present invention has been illustrated by a description of various preferred embodiments and while these embodiments have been described in detail, it is not intended to restrict or in any way limit the scope of the appended claims to such detail. Additional advantages and modifications within the spirit and scope of the invention will readily appear to those skilled in the art. For example, as will be appreciated, the use of distributed CPU-based controllers 49, 50, 54, 55, 62 permits a high degree of flexibility in terms of which controllers are utilized for a specific function. For example, in the described embodiment, the vehicle controller 50 senses the states of the vehicle light switches 46, 47, 108 and transmits those states to the plow controller 54. As will be appreciated, in a different embodiment, the vehicle controller 50 may transmit the states of the vehicle light switches 46, 47, 108 to the plow switch controller 49 that, in turn, functions to transmit the states of the vehicle light switches 46, 47, 108 to the plow controller 54.

In the described embodiment, the plow output device states that are determined by the plow switch controller 49 are transmitted directly to the plow controller 54. Alternatively, plow output device states can be transmitted from the plow switch controller 49 to the vehicle controller 50 prior to being transmitted to the plow controller 54.

In the described embodiment, a secure communications link is described between the plow switch controller 49 and the plow controller 54. As will be appreciated, in other embodiments, the same technology can be used to provide one or more secure communications links between any of the controllers.

In the described embodiment, a solenoid current sensor 130 associated with the plow controller 54 is used to detect the type of plow mounted on the vehicle 20. As will be appreciated, in other embodiments, a spreader solenoid current sensor can be used in association with spreader controller 62 to automatically detect what type of spreader is mounted on the vehicle, for example, a hopper spreader or a tailgate spreader. Further, the state of the output signal from the spreader solenoid current sensor is transmitted to the spreader switch controller 55 that is then operative to automatically program the spreader control switches 56 to operate the specific type of spreader being used. As will further be appreciated, the same technology can be used to detect a wide range of accessories that may be mounted on the vehicle.

In the described embodiment, the spreader switch controller 55 is in electrical communications with the spreader controller 62 but not with any of the plow controllers 49, 50, 54. As will be appreciated, in an alternative embodiment, the single wire communications bus 88 may be connected to the single wire communications bus 89 via an optional single wire 116. In that embodiment, any of the controllers 49, 50, 54, 55 and 62 are capable of electrical communications with any of the other controllers. With such a configuration, the states of the spreader output devices could be transmitted from the spreader switch controller 55 to the vehicle controller 50 and thereafter, transmitted to the spreader controller 62.

Not only can the routing of communications between the controllers be modified, but the execution of various programs can be transferred from one controller to another. For example, the execution of plow operation routines 616, of FIG. 6A, that is executed by the CPU 74 within the plow switch controller 49, may alternatively be executed by the CPU 74 of the plow controller 54. Similarly, the execution of spreader operation routines, at 664 of FIG. 6B, that is currently executed in the CPU 74 of the spreader switch controller 55, may alternately be executed in the CPU 74 of the spreader controller 62. Thus, the utilization of distributed controllers that are in electrical communications over a CAN single wire communications bus provides enormous flexibility in the control of accessories that are attached to the vehicle.

Referring to FIG. 2B, while LEDs 83 are shown as the sensory perceptible indicators, other visual, audible or other indicators can be used. Referring to FIG. 2B, it should be noted that the switches 46, 47 and 108 shown as part of the OEM vehicle wiring are only an example of such wiring. As will be appreciated, there are many different configurations of lighting switches and wiring, and the invention claimed herein is not limited to the vehicle wiring shown and described. Similarly, there are many different configurations of the vehicle lights 26, and the invention claimed herein is not limited to the vehicle lights shown and described.

Therefore, the invention in its broadest aspects is not limited to the specific detail shown and described. Consequently, departures may be made from the details described herein without departing from the spirit and scope of the claims which follow.

What is claimed is:

1. An apparatus for controlling an accessory having an electrically operable device and being attachable to a vehicle, the apparatus comprising:
a switch adapted to be mounted on the vehicle remote from the accessory and operable by a user, the switch providing a command signal to command an operation of the electrically operable device on the accessory;
a first controller adapted to be mounted on the vehicle and electrically connected to the switch for receiving the command signal;
a second controller adapted to be mounted on the accessory and electrically connected to the electrically operable device;
first and second dedicated communications wires electrically connected to the first and second controllers, respectively;
a first coupling member electrically connected to the first dedicated communications wire;
a second coupling member electrically connected to the second dedicated communications wire, the second coupling member being connectable to the first coupling member upon the accessory being mounted on the vehicle, thereby connecting the first and second dedicated communications wires to form a single dedicated communications wire, and the second coupling member being disconnectable from the first coupling member upon the accessory being removed from the vehicle,
the first controller providing the command signal to the second controller via the single dedicated communications wire and the second controller operating the electrically operable device on the accessory in response to the first coupling member being connected to the second coupling member and receiving the command signal.

2. The apparatus for controlling an accessory of claim 1 wherein the first and second controllers comprise respective first and second transceivers for multiplexing signals over the single dedicated communications wire between the first and the second controllers.

3. The apparatus for controlling an accessory of claim 2 wherein the first and second controllers further comprise respective first and second CPUs electrically connected to respective first and second transceivers.

4. The apparatus for controlling an accessory of claim 3 wherein the first controller further comprises a first interface circuit electrically connected between the first CPU and the switch for passing the command signal from the switch to the first CPU.

5. The apparatus for controlling an accessory of claim 4 wherein the second controller further comprises a second driver circuit electrically connected between the second CPU and the electrically operable device for providing an output signal to the electrically operable device in response to an operation of the second CPU.

6. The apparatus for controlling an accessory of claim 5 wherein the accessory further has an input device providing an input signal and second controller further comprises a second interface circuit electrically connected between the second CPU and the input device for passing the input signal from the input device to the second CPU.

7. The apparatus for controlling an accessory of claim 6 further comprising output devices located proximate the switch and the first controller further comprises a first driver circuit electrically connected between the first CPU and the output for operating the output device in response to receiving the input signal from the second controller.

8. A method for controlling an accessory having an electrically operable device and being attachable to a vehicle, the method comprising:
providing a first signal to command an operation of the electrically operable device on the accessory with a switch mounted on the vehicle remote from the accessory and operable by a user;
receiving the first signal with a first controller mounted on the vehicle and electrically connected between the switch and a first communications wire;
providing a first coupling member electrically connected to the first dedicated communications wire and a second coupling member electrically connected to a second dedicated communications wire, the second coupling member being connectable to the first coupling member upon the accessory being mounted on the vehicle, thereby connecting the first and second dedicated communications wires to form a single dedicated communications wire, and the second coupling member being disconnectable from the first coupling member upon the accessory being removed from the vehicle;
receiving, in response to the first coupling member being connected to the second coupling member, a second signal with a second controller mounted on the accessory and electrically connected between the electrically operable device and the second communications wire; and
operating the electrically operable device on the accessory in response to the second controller receiving the second signal.

9. The method of claim 8 further comprising:
encoding the second signal in the first controller to provide an encoded command signal;
transmitting the encoded second signal across the single dedicated communications wire from the first controller to the second controller; and
decoding the encoded second signal in the second controller.

10. The method of claim 9 further comprising:
providing a plurality of command signals to command operations of the electrically operable device; and
multiplexing the plurality of command signals on the dedicated single wire to transmit the plurality of command signals from the first controller to the second controller.

11. The method of claim 10 further comprising:
scanning states of input and output devices associated with the electrically operable device with the second controller; and
transmitting the states of the input and output devices over the single dedicated communications wire from the second controller to the first controller.

12. The method of claim 11 further comprising:
providing a plurality of signal states representing states of the input and output devices; and
multiplexing the plurality of signal states on the dedicated single wire to transmit the plurality of command signals from the second controller to the first controller.

13. An apparatus for controlling a plow having an electrically operable device and being attachable to a vehicle, the apparatus comprising:
a plow control adapted to be mounted on the vehicle remote from the plow and having a switch operable by a user, the switch providing a command signal to command an operation of the electrically operable device on the plow;
a first controller located in the proximity of the switch and electrically connected to the switch for receiving the command signal;
a second controller adapted to be mounted on the vehicle;
a third controller adapted to be mounted on the plow and electrically connected to the electrically operable device;
a first dedicated communications wire electrically connected to the first and second controllers, respectively;
a second dedicated communications wire electrically connected to the third controller;
a first coupling member electrically connected to the first dedicated communications wire;
a second coupling member electrically connected to the second dedicated communications wire, the second coupling member being connectable to the first coupling member upon the plow being mounted on the vehicle, thereby connecting the first and second dedicated communications wires to form a single dedicated communications wire, and the second coupling member being disconnectable from the first coupling member upon the plow being removed from the vehicle,
the first controller providing the command signal to the third controller via the single dedicated communications wire and the third controller operating the electrically operable device on the accessory in response to the first coupling member being connected to the second coupling member and receiving the command signal.

14. The apparatus for controlling a plow of claim 13 wherein the plow has plow lights and the vehicle has vehicle lights controllable by a vehicle light switch, and the apparatus further comprises:
an electrical connection between the vehicle light switch and the second controller;
an electronic switch electrically connected between the vehicle light switch and the vehicle lights; and
the third controller communicating with the first and second controllers over the single dedicated communications wire upon the first and second coupling members being connected together, and the second controller operating the electronic switch to disable the operation of the vehicle lights by the vehicle light switch in response to the second and third controllers communicating over the single dedicated communications wire.

15. The apparatus for controlling an accessory of claim 13 wherein the first, second and third controllers comprise respective first, second and third transceivers for multiplexing signals across the single dedicated communications wire between the first, second and third controllers.

16. A method for controlling a plow wherein the plow has a plow light and the vehicle has a vehicle light controllable by a vehicle light switch, the method comprising:
providing a first signal operable to illuminate the vehicle light in response to the vehicle light switch being operated;
detecting the first signal with a first controller mounted on the vehicle;
detecting automatically a presence of a single dedicated communications wire between the first controller and a second controller mounted on the plow in response to the plow being mounted on the vehicle;
changing a state of an electronic switch electrically connecting the vehicle light switch with the vehicle lights to a state electrically disconnecting the vehicle light switch from the vehicle lights;
providing a second signal with the first controller in response to detecting the first signal;
transmitting the second signal to the second controller over the single dedicated communications wire;
illuminating automatically the plow light in response to the second controller receiving the second signal and hence, in response to the vehicle light switch being operated.

17. The method of claim 16 further comprising:
detecting automatically an absence of the single dedicated communications wire between the first controller and a second controller mounted on the plow in response to the plow being removed from the vehicle; and
changing the state of the electronic switch to a state electrically connecting the vehicle light switch to the vehicle lights, thereby illuminating the vehicle lights in response to the first signal from the vehicle light switch.

18. An apparatus for controlling an accessory having an accessory light and being attachable to a vehicle having a vehicle light operable in a DRL mode, the apparatus comprising:
a first controller adapted to be mounted on the vehicle, the first controller detecting a supply voltage operable to illuminate the vehicle light in a DRL mode and providing a signal representing a vehicle DRL operation; and
a second controller adapted to be mounted on the accessory and electrically connectable to the first controller upon the accessory being mounted on the vehicle, the second controller operating the accessory light in a DRL mode in response to receiving the signal representing a vehicle DRL operation.

19. An apparatus for controlling a plow having a plow light and being attachable to a vehicle having a vehicle light operable in a DRL mode, the apparatus comprising:
a first controller adapted to be mounted on the vehicle, the first controller detecting a supply voltage operable to illuminate the vehicle light in a DRL mode and providing a signal representing a vehicle DRL operation; and
a second controller adapted to be mounted on the plow and electrically connectable to the first controller upon the plow being mounted on the vehicle, the second controller operating the plow light in a DRL mode in response to receiving the signal representing a vehicle DRL operation.

20. The apparatus for controlling a plow of claim 19 further comprising a switching device electrically connected to the vehicle light for switching the vehicle light off in response to the signal representing a vehicle DRL operation and the plow being mounted on the vehicle.

21. An apparatus for controlling a plow having a plow light and being attachable to a vehicle having a vehicle light operable by a supply voltage, the apparatus comprising a first controller adapted to be mounted on the vehicle and electrically connected between the supply voltage and the vehicle light, the first controller detecting the vehicle light being operable in a DRL mode.

22. The apparatus for controlling a plow of claim 21 further comprising a second controller adapted to be mounted on the plow and electrically connectable to the first controller upon the plow being mounted on the vehicle, the second controller operating the plow light in a DRL mode in response to the first controller determining the vehicle light is operable in a DRL mode.

23. A method of operating a plow light on a plow attachable to a vehicle having a vehicle light, the method comprising:
detecting a supply voltage operable to illuminate the vehicle light;
determining the supply voltage is operable to illuminate the vehicle light in a DRL mode; and
automatically operating the plow light in a DRL mode in response to determining the supply voltage is operable to illuminate the vehicle light in a DRL mode.

24. A method of operating a plow light on a plow attachable to a vehicle having a vehicle light, the method comprising:
operating the vehicle light in the DRL mode;
determining with a first controller on the vehicle the vehicle light being operated in the DRL mode;
providing a signal from the first controller to a second controller mounted on the plow representing the DRL mode of the vehicle light; and
automatically operating the plow light in a DRL mode with the second controller in response to the second controller receiving the signal.

25. A method of operating a light on a plow attachable to a vehicle having a vehicle light operable in a DRL mode in response to a DRL supply voltage, the method comprising:
detecting the DRL supply voltage with a first controller mounted on the vehicle; and
determining with the first controller the DRL supply voltage being operable to illuminate the vehicle light in the DRL mode.

26. The method of claim 25 further comprising providing a DRL signal to a second controller mounted on the plow in response to the plow being attached to the vehicle.

27. The method of claim 26 further comprising operating the plow light in a DRL mode with the second controller in response to the DRL signal.

28. The method of claim 27 further comprising switching the vehicle light off in response to the plow being attached to the vehicle.

29. An apparatus for controlling an accessory having an electrically operable device and being attachable to a vehicle, the apparatus comprising:
an accessory switch adapted to be mounted on the vehicle remote from the accessory and operable by an operator, the accessory switch adapted to command an operation of the electrically operable device on the accessory;
a first controller adapted to be mounted on the vehicle, the first controller providing an accessory command signal for the electrically operable device in response to detecting an operation of the accessory switch; and
a second controller adapted to be mounted on the accessory and electrically connectable to the first controller upon mounting the accessory on the vehicle, the second controller operating the electrically operable device in response to receiving the accessory command signal from the first controller, the second controller comprising a circuit electrically connected to the electrically operable device for sensing an erroneous electrical operation of the electrically operable device, the second controller terminating the operation of the electrically operable accessory in response to the circuit sensing the erroneous electrical operation.

30. The apparatus of claim 29 wherein the electrically operable device is a light and the circuit senses an excessive current flowing through the light.

31. The apparatus of claim 29 wherein the electrically operable device is a solenoid and the circuit senses an excessive current flowing through the solenoid.

32. A method of controlling an accessory having an electrically operable device and being attachable to a vehicle, the method comprising:
producing an operating command for the electrically operable device on the accessory from an accessory switch mounted inside the vehicle remote from the accessory and operable by a user;
transmitting the operating command from a first controller mounted proximate the accessory switch inside the vehicle to a second controller mounted on the accessory outside the vehicle and electrically connectable to the first controller upon mounting the accessory;
operating the electrically operable device in response to the second controller receiving the accessory command signal from the first controller;
detecting automatically with the second controller an erroneous electrical operation of the electrically operable device; and
terminating automatically with the second controller the operation of the electrically operable accessory in response to detecting the erroneous electrical operation.

33. The method of claim 32 further comprising sensing an excessive current flow in the electrically operable device.

34. An apparatus for detecting a presence of a particular accessory mounted on a vehicle, the particular accessory having an electrically operable device unique to the particular accessory, the apparatus comprising:
a first controller adapted to be mounted on the vehicle; and
a second controller adapted to be mounted with the particular accessory and electrically connectable to the first controller upon the particular accessory being mounted on the vehicle, the second controller comprising a circuit electrically connected to the electrically operable device for sensing electrical continuity with the electrically operable device, the second controller providing a signal to the first controller having a first state identifying a presence of the particular accessory in response to the circuit sensing electrical continuity with the electrically operable device unique to the particular accessory.

35. The apparatus of claim 34 wherein the second controller provides a signal to the first controller having a second state representing a non-presence of the particular accessory in response to the circuit not sensing electrical continuity with the electrically operable device unique to the particular accessory.

36. The apparatus of claim 34 wherein the particular accessory is a V-blade plow and the electrically operable device unique to the V-blade plow is a first solenoid, and the second controller provides a first signal state to the first controller representing a presence of the V-blade plow in response to the circuit sensing electrical continuity with the first solenoid.

37. The apparatus of claim 36 wherein the particular accessory is a straight blade plow having a second solenoid but not the first solenoid, and the second controller provides a second signal state to the first controller representing a non-presence of the V-blade plow in response to the circuit sensing an absence of electrical continuity with the first solenoid.

38. A method of identifying a particular accessory mounted on a vehicle, the accessory having an electrically operable device unique to the particular accessory, the method comprising:
mounting the particular accessory on the vehicle;
electrically connecting a first controller mounted on the vehicle with a second controller mounted with the particular accessory;
sensing with a circuit in the second controller electrical continuity with the electrically operable device unique to the particular accessory; and
providing a signal from the second controller to the first controller having a first state representing a presence of the particular accessory in response to the circuit sensing electrical continuity with the electrically operable device unique to the particular accessory.

39. The method of claim 38 further comprising:
sensing with the circuit in the second controller an absence of electrical continuity with the electrically operable device unique to the particular accessory; and
providing the signal from the second controller to the first controller having a second state representing a non-presence of the particular accessory in response to the circuit sensing an absence of electrical continuity with the electrically operable device unique to the particular accessory.

40. The method of claim 38 wherein the particular accessory is a V-blade plow and the electrically operable device is a first solenoid, the method further comprising:
sensing with the circuit in the second controller electrical continuity with the first solenoid; and
providing the signal from the second controller to the first controller having a first state representing a presence of the V-blade plow in response to the circuit sensing electrical continuity with the first solenoid.

41. The method of claim 40 wherein the particular accessory is a straight blade plow having a second solenoid but not the first solenoid, the method further comprising:
sensing with the circuit in the second controller an absence of electrical continuity with the first solenoid; and
providing the signal from the second controller to the first controller having a second state representing a non-presence of the V-blade plow in response to the circuit sensing the absence of electrical continuity with the first solenoid.

42. An apparatus for securing communications between a vehicle and an accessory being mountable on a vehicle, the accessory requiring an electrically operable device for its operation, the apparatus comprising:
a first controller adapted to be mounted on the vehicle;
a user-operable interface controller electrically connectable to the first controller and being operable to provide a security code to the first controller; and
a second controller adapted to be mounted with the accessory and being electrically connectable to the first controller upon the accessory being mounted on the vehicle, the second controller being operatively connected to the electrically operable device only in response to the second controller receiving the security code from the first controller.

43. The apparatus of claim 42 wherein the accessory is a plow and the electrically operable device is a solenoid.

44. A method of securing communications between a vehicle and an accessory being mountable on a vehicle, the accessory requiring an electrically operable device for its operation, the method comprising:
providing a first security code with a user-operable interface controller;
storing the first security code in a first controller mounted on the vehicle and electrically connected to the interface controller;
transmitting the first security code from the first controller to a second controller mounted with the accessory and being electrically connectable to the first controller upon the accessory being mounted on the vehicle;
storing the first security code in the second controller;
operating the electrically operable device with the second controller in response to the first controller subsequently transmitting the first security code to the second controller; and
disabling operation of the electrically operable device with the second controller in response to the first controller subsequently transmitting a second security code to the second controller that does not match the first security code.

45. The method of claim 44 further comprising:
electrically connecting the interface controller to the first controller prior to providing the first security code; and
electrically disconnecting the interface controller from the first controller after storing the first security code in the first controller.

46. The method of claim 44 wherein the accessory is a plow and the electrically operable device is a solenoid.

47. An apparatus for securing communications between a vehicle and an accessory being mountable on a vehicle, the accessory requiring an electrically operable device for its operation, the apparatus comprising:
a user-operable switch adapted to be mounted on the vehicle remote from the accessory, the switch providing a command signal enabling operation of a security system;
a first controller adapted to be mounted on the vehicle and electrically connected to the switch, the first controller automatically producing and storing a first security code in response to receiving the command signal;
a second controller adapted to be mounted on the accessory and electrically connected to the electrically operable device;
first and second dedicated communications wires electrically connected to the first and second controllers, respectively;
a first coupling member electrically connected to the first dedicated communications wire;
a second coupling member electrically connected to the second dedicated communications wire, the second coupling member being connectable to the first coupling member upon the accessory being mounted on the vehicle, thereby connecting the first and second dedicated communications wires to form a single dedicated communications wire; and
the first controller providing the first security code to the second controller via the single dedicated communications wire and the second controller being operatively connected to the electrically operable device only in response to the second controller receiving the first security code from the first controller.

48. The apparatus of claim 47 wherein the second controller disables operation of the electrically operable device in response to the first controller subsequently transmitting a second security code to the second controller that does not match the first security code.

49. The apparatus of claim 47 wherein the accessory is a plow and the electrically operable device is a solenoid.

50. A method of securing communications between a vehicle and an accessory being mountable on a vehicle, the accessory requiring an electrically operable device for its operation, the method comprising:
enabling a security system with user-operated switches on a first controller mounted on the vehicle;
automatically providing a first security code with the first controller;
storing the first security code in the first controller;
transmitting the first security code to a second controller mounted with the accessory and being electrically connectable to the first controller upon the accessory being mounted on the vehicle;
storing the first security code in the second controller;
operating the electrically operable device with the second controller in response to the first controller subsequently transmitting the first security code to the second controller; and
disabling operation of the electrically operable device with the second controller in response to the first controller subsequently transmitting a second security code to the second controller that does not match the first security code.

51. The method of claim 50 further comprising transmitting the first security code to the second controller over a single dedicated communications wire.

52. The method of claim 50 wherein the accessory is a plow and the electrically operable device is a solenoid.
